(19) United States
(12) Patent Application Publication
(10) Pub. No.: US 2006/0224696 A1
(43) Pub. Date: Oct. 5, 2006

(54) Targeted advertorial and multimedia delivery system and method

(76) Inventors: Blair King, Bryn Athyn, PA (US); Kevin Furey, Villanova, PA (US); Justin C. Allen, Meadowbrook, PA (US)

Correspondence Address: Justin C. Allen, 2101 Valley Road, Meadowbrook, PA, 19046, US

(21) Appl. No.: 11/097,105

(22) Filed: Apr. 1, 2005

(51) Int. Cl. G06F 15/16

(52) U.S. Cl. 709/218

(57) ABSTRACT

A system and method for the distribution and display of multimedia content to at least one remote location is described. The system includes a first server for storing and sending multimedia content, a second server located in at least one location remote from the first server, where the second server is communicatively connected to the first server via a network. At least one display unit is communicatively connected to the second server for displaying the multimedia content, where the first server selectively sends the multimedia content to the second server for displaying on the at least one display unit at the at least one location remote from the first server, and where the multimedia content is individually targeted for each of the at least one location remote from the first server.

### FIELD OF THE INVENTION

The invention relates to multimedia delivery, and, more particularly, to a system and method for delivering targeted advertorial and multimedia content throughout a networked environment.

### BACKGROUND OF THE INVENTION

While the equipment used by physicians in the course of their practice may be state of the art, the same cannot be said for the state of medical office waiting rooms and lounges. Waiting rooms, such as those found in medical or dental offices, typically portray a dull and uninspiring atmosphere. For example, the standard doctor's office usually comprises several uncomfortable chairs, a coat rack and some magazine subscriptions. As is usually the case, patients are already uncomfortable from illness or other health related reason, and could benefit from something to lift their spirits. From the perspective of the doctor or practice group manager in charge of the waiting room and other facilities, it behooves them to provide the most comfortable and relaxing environment possible. By doing this, the doctor can offer a better experience for their patients, and hopefully promote and increase their practice. However, improvements to the quality and comfort of furniture, as well as other entertaining features of the waiting room, usually come at a financial cost too high for an office waiting room manager to justify.

At the same time, medical product developers and manufacturers are always looking to maximize the effectiveness of their product marketing techniques. Generally, advertisements or other broadcast messages are disseminated through television, radio programming, or through newspaper or journal sections. While these techniques can potentially reach a large segment of the population, that segment of the population is relatively undefined, which forces the advertiser to prepare their message in a format that is difficult for any particular person to relate to. It goes without saying that advertising targeted to particular individuals or groups of individuals, or direct to consumer advertising, would help maximize marketing effectiveness.

It is also well understood that the schedules of physicians and their office staff have become increasingly more rigorous and time consuming. Doctors and staff members alike do not have the same time or tolerance for visitations by people other than their patients, such as medical product sales representatives, as they have in the past. Also, because many sales representatives work on some form of commission based system, their sales techniques may cause medical office personnel to feel annoyed or uncomfortable when communicating face to face with the sales representative. In many cases, it might be more effective and more profitable for medical product companies to reach physicians and their staff quickly and more effectively throughout the work day, and in a more discreet and unobtrusive manner.

Thus, a need exists to provide an educational and entertaining waiting room environment that reduces patient anxiety, while at the same time providing medical product companies with a direct to consumer advertising platform to help maximize their marketing efforts in a cost and time efficient manner. Additionally, there is a need for medical product companies and medical associations alike to have greater access to medical practitioners in both real-time and casually throughout the work day.

### SUMMARY OF THE INVENTION

A system for the distribution and display of multimedia content to at least one remote location is described. The system includes a first server for storing and sending multimedia content, a second server located in at least one location remote from the first server, where the second server is communicatively connected to the first server via a network. At least one display unit is communicatively connected to the second server for displaying the multimedia content, where the first server selectively sends the multimedia content to the second server for displaying on the at least one display unit at the at least one location remote from the first server, and where the multimedia content is individually targeted for each of the at least one location remote from the first server.

Also described is a method for distributing and displaying multimedia content to at least one remote location. The method includes selecting multimedia content stored on a first server, selecting a second server located in at least one location remote from the first server, where the second server is communicatively connected to the first server via a network, transmitting the multimedia content from the first server to the second server, and displaying the multimedia content on at least one display unit communicatively connected to the second server, where the multimedia content is individually targeted for each of the at least one location remote from the first server.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a generalized schematic of a computer network in accordance with an exemplary embodiment of the present invention;

FIG. 2 is a schematic of a localized network in accordance with an exemplary embodiment of the present invention; and

FIG. 3 is an exemplary embodiment of a localized network designed for a medical office.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical multimedia delivery systems and methods of using the same. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

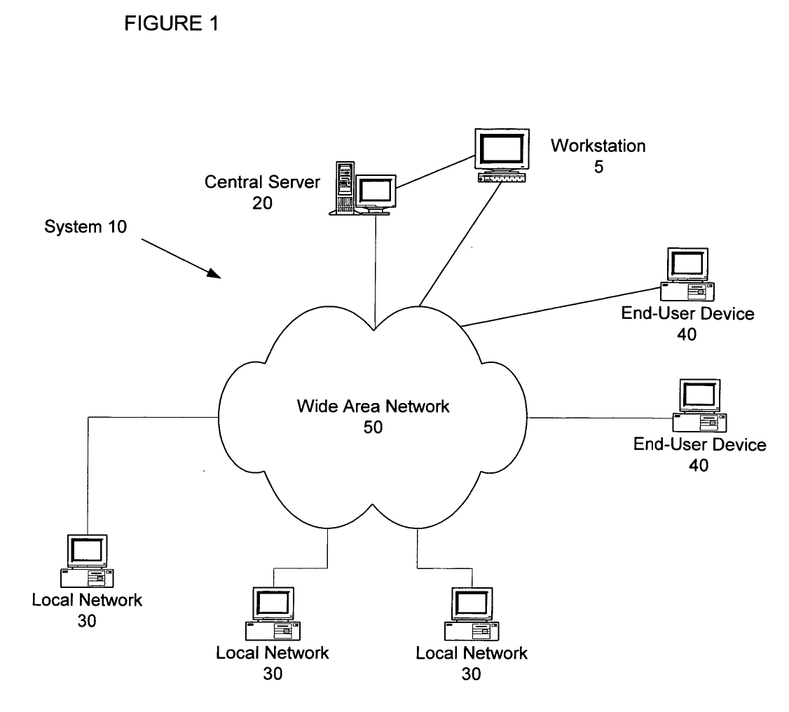

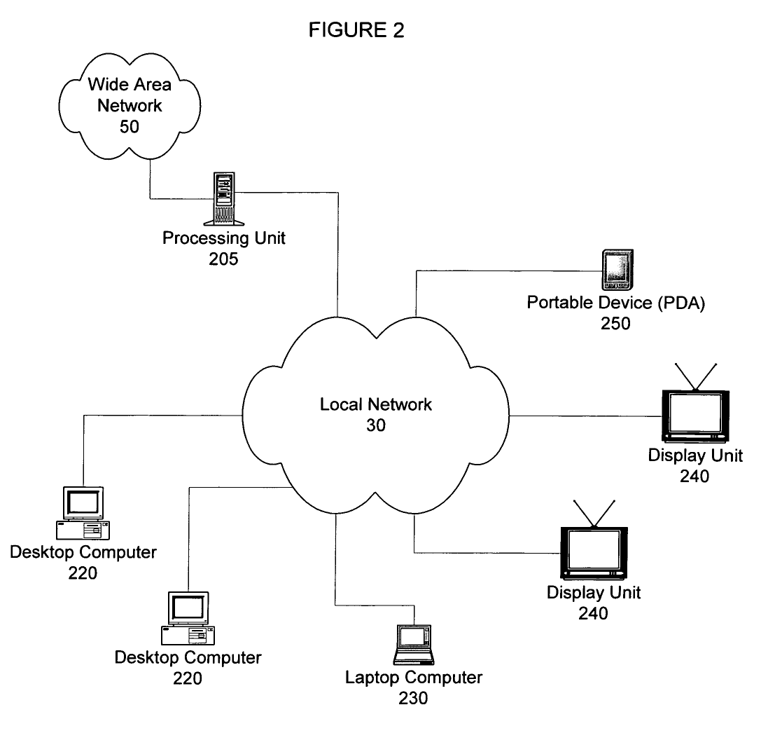

In an exemplary embodiment of the present invention, a computer network may be used to distribute data from a central location to any number of end-users located remotely from the central location. As seen in FIG. 1, system 10 may include a workstation 5, central server 20, local networks 30, end-user devices 40, and wide area network 50. Workstation 5 may include any hardware and software necessary for the filming, editing, and processing of computer transferable files. For example, workstation 5 may include a camera for taking still frame shots or full motion videos, and a desktop or laptop computer with video processing and editing software for the creation and manipulation of video files. Workstation 5 may be connected directly to central server 20 through a local area network, or may be remotely connected via wide area network 50, such that files may be sent from workstation 5 to central server 20 for subsequent distribution to local networks 30 and end-user devices 40. Central server 20 may be one server or a combination of servers, providing functionality as a network mainframe server, a web server, a mail server and central database server, which may be maintained at any convenient location by a system administrator. Central server 20 may include at least one processor, standard input and output devices, as well as all hardware and software typically found on personal computing devices for storing data and running programs, and for sending and receiving data over a network. Central server 20 may be connected to any number of local networks 30 or end-user devices 40 via a wide area network 50, such that wide area network 50 allows for the communication of files, email, and any other data format between central server 20, local networks 30 and end-user devices 40. The system administrator may add any number of central servers 20, such that system 10 may provide efficient and reliable service to local networks 30 and end-user devices 40 as the number of local networks 30 and end-user devices 40 may increase. Local networks 30 may be any one location or any number of locations remote from central server 20, such that local networks 30 may be communicatively connected to central server 20 via wide area network 50. For example, a local network may be a physician's office, a hospital waiting room, or a medical school lounge or cafeteria. Further detail of local networks 30 will be described later in FIG. 2. End-user devices 40 may be any sort of personal computing device, such as a desktop PC, a laptop, a PDA, a pager, or a digital or cellular phone, for example, such that end-user devices 40 may be communicatively connected to central server 20 via wide area network 50. Wide area network 50 may be any suitable networked system understood by those having ordinary skill in the art, such as, for example, an open, wide area network (e.g., the internet), an electronic network, an optical network, a wireless network, a physically secure network or virtual private network, and any combinations thereof. Wide area network 50 may also include any intermediate nodes, such as gateways, routers, bridges, internet service provider networks, public-switched telephone networks, proxy servers, firewalls, and the like, such that wide area network 50 may be suitable for the transmission of data throughout system 10. Additionally, system 10 may utilize any conventional operating platform or combination of platforms, and with any conventional networking and communications software.

As illustrated in FIG. 2, a local network 30 is described. Local network 30, like wide area network 50, may be any sort of network suitable for receiving data and distributing the data to any number of network ready devices over a limited physical area, such as an electronic network, an optical network, a wireless network, a physically secure network or virtual private network, and any combinations thereof. Local network 30 may also include at least one processing unit 205 for communications into and out of wide area network 50, and any intermediate nodes such as gateways, routers, bridges, internet service provider networks, public-switched telephone networks, proxy servers, firewalls, and the like, such that it may be suitable for sending and receiving information through wide area network 50, as well as the transmission of data throughout local network 30. Local network 30 may include any number of desktop computers 220, laptops 230, display units 240, and other portable devices 250. Desktop computers 220 and laptops 230 may be of any sort understood by those having ordinary skill in the art, having at least one processor, standard input and output devices, as well as all hardware and software typically found on personal computing devices for storing data and running programs, and for sending and receiving data over a network. Display units 240 may include a fully functional computer, such as desktop computer 220, which may include any necessary software to perform all of the functions of receiving, recording, storing, manipulating, and displaying audio and video files. Display units 240 may also be monitors, televisions, flat panel displays, projection televisions, or any other visual displaying device, suitable for displaying audio and video files. Further, display units 240 may be of any size or dimension, such that display units 240 may be of a size appropriate to fit within its local surroundings. Portable devices 250 may include any handheld or portable device, such as PDAs, pagers, and digital and cellular phones, for example. Any device capable of connecting to a local network may also be included in local network 30.

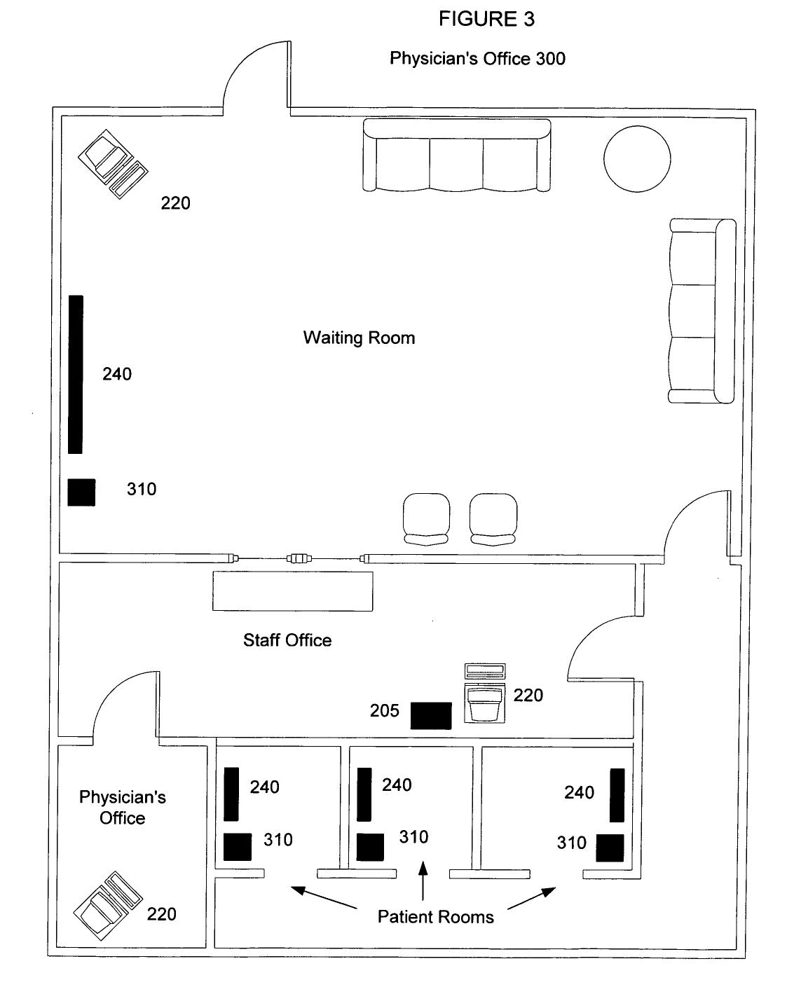

Depending on the physical establishment in which local network 30 may be situated, any combination of components may be used. For example, as illustrated in FIG. 3, when local network 30 is situated in a physician's office 300, local internet service providers may install and activate a broadband connection, such as a T1 line, fiber optic cable, or DSL, to a central point in the office, which may feed into a processing unit 205 with a standard, commercially available wireless router. A display unit 240 may be positioned on a wall in the general waiting room, as well as in any number of individual patient rooms. A desktop computer 220 may be positioned in the staff office, physician's personal office, as well as in the general waiting room. Additional information relating to content displayed on display units 240 or desktop computers 220 may be located near these devices 310. Such information may be in the form of paper pamphlets, or via a computing device with an attached printer. Also, the physician may carry a handheld device (not shown), such as a PDA, which may also be connected into local network 30. It will be understood by those skilled in the art that any combination of internet ready devices may be incorporated or used in combination with the present invention, as well as their positioning within the physical establishment covered by local network 30, such that the positioning of any particular component may maximize the aesthetic qualities of the establishment as well as maximize the attention of viewers within the establishment.

In the event that two or more devices are located in the same room, one or more of the devices may have any audio functionality temporarily or permanently disabled, so that any one device is not considered a distraction of any other device. Also, depending on which component of system 10 is being used, particular components of local network 30 may be inaccessible or discreetly hidden from view. Returning to the example of the physician's office, any processing unit used to feed display unit 240 may be positioned so it may be inaccessible to patients in the general waiting room, thus providing only the display unit 240 for viewing, and not a mechanism for turning display unit 240 on or off, or changing what files or content is being shown on the screen. This may be particularly important, so that providers of content to be run on display unit 240 may be assured their content will not be removed or disrupted during any point of the day.

The at least one processing unit 205 of local network 30 may be accessed and programmed remotely by central server 20, such as by using PC AnyWhere networking and communications software on the operating system platform. The remote access software may permit central server 20 to access the processing units 205 of local networks 30 for transmission of files and other data, as well as for performing routine diagnostics, updates and configuration changes. By accessing the processing units 205 of local network 30 remotely, time and costs may be saved from traveling to every establishment containing a local network 30. It should also be understood that it may not be desirable to have people outside of system 10 or out of the control of the systems administrator activating or otherwise handling any of the components of local networks 30, other than may be intended by system 10.

As mentioned earlier, the present invention may provide a system for sending a file or set of files, from central server 20 to the components of local networks 30. These files may be any sort of files suitable for containing multimedia content, such as JPEG, MPEG, MPEG2, MOV, RAM/RM, AVI or MP3, for example. Other sorts of files, such as email, pdf, and the like, may also be transmitted. Transmission of files throughout system 10 may be done using standard integration techniques, such as FTP or other suitable protocol, either manually by selection of particular files for particular destination local networks 30 by the systems administrator, or may be automated with suitable software applications, and managed by the systems administrator.

As explained above, the files or data sent from central server 20 to local networks 30 may contain any sort of multimedia content suitable for viewers at each particular local network 30. Virtually any type of multimedia content may be used within the present invention, and that such content may be targeted or customized to the specialty of a particular establishment containing a local network 30. By way of non-limiting example, when the establishment containing local network 30 is a pediatrician's office, the content of the files may be sent from central server 20 to a processing unit 205 of local network 30 within the pediatrician's office, and displayed on display units 240 in the general waiting room. Content for the pediatrician's office may include educational information related to pediatric practice, such as warning signs of certain childhood diseases, the advantages and/or disadvantages of vaccinations, breastfeeding, allergies, or any other issue related to children's health. Such content may also include advertisements for products, such as baby formula, fever reducers for children, or virtually any product designed for the improvement of children's health. Also included may be messages from product or device manufacturers providing information to counteract bad public press, such as against discriminatory propaganda that is not factually based, regarding a product that is being questioned for its safety of use. Additionally, such content may include advertorial information relating to healthcare, such as medical insurance, or even promotional information from the pediatricians of that particular office, introducing themselves or the members of their practice, and any other information they wish to convey to their patients. Content relating to general interest issues may also be included, such as nature scenes accompanied by music, documentaries of medical discoveries, or anything thought to be entertaining to people waiting in the office. It should be understood that the present invention may also provide a real-time feed for any sort of news, weather, or financial information programs, for example, which may appear as a banner across a portion of any display unit 240.

These files may be presented to viewers in a variety of formats, such as, for example, in still frames, flash technology, or streamed video. Also, any sort of high definition broadcasting format may be used, should display units 240 be suitable for displaying high definition content. For example, a file or sequence of files may be presented as a playlist, which may be sent from central server 20 to the processing unit 205 of local network 30 during times of the day or night when the target establishment is closed. Once the files have been successfully received by the processing unit 205 of local network 30, the playlist may be remotely activated by the systems administrator and run repetitiously as a loop on any one of display units 240. Alternatively, a streaming file may be run, or other real-time live feed signal used for transmission of data from central server 20 throughout local network 30.

Advertisers and other groups, referred to herein as content providers, wanting to use the present invention to reach the public may first provide the system administrator with content in the form of a computer readable file. The systems administrator may provide any content providers with a set of specifications for the file to conform to. These specifications may define a particular file format or formats that may be relatively simple for content providers to meet, and the process of the systems administrator for incorporating the files into particular playlists, streaming video, or other delivery format to local networks 30 may be simplified.

In another embodiment of the present invention, the content of files submitted by the content providers may be reviewed by a board or other reviewing body so that all content meets a certain set of standards that may be determined by system 10. Such standards may be independent of any standards required for public advertising and entertainment, as determined by state or federal regulations, such as those set by the Food and Drug Administration (FDA) or the Federal Communications Commission (FCC). For example, standards may be based on quality, educational level, morality, and any other feature that may assist in screening out content that may create an unwanted image of system 10 or the other participating content providers. Once the provided content is in the desired format and meets any such system 10 standards, the file or files may be stored on central server 20 or other storage location (not shown) within system 10.

After the individual content files have been stored, the system administrator may incorporate the files into any sort of playlist or streaming video mechanism agreed to by the content provider and the system administrator. Playlists may be developed for distribution to a specific local network 30, or to any number of local networks 30, such that each playlist may be suitable for its targeted local network 30. For example, a playlist designed for a particular cardiologist's office may contain heart related product advertisements, some educational information relating to proper exercise levels for people recovering from a bypass, and a welcoming presentation by the practicing cardiologist, where he may relate his working experience and introduce his staff. Alternatively, the same playlist without the welcoming presentation by the practicing cardiologist may be sent to all cardiologist offices participating in system 10. Whenever the content in any playlist changes, the playlist may be reprogrammed and redistributed to the appropriate local network 30 at the next available downloading period.

As mentioned previously, system 10 may provide additional information relating to content displayed on display units 240 or desktop computers 220. Referring back to FIG. 3, such information may be in the form of paper pamphlets, or via a computing device 310 with an attached printer located near display units 240 or desktop computers 220. Alternatively, such additional information may be located with a blocked portion of the content displayed on display units 240 or desktop computers 220. Such a device 310 may itself be a display unit, and may further include a touchscreen to allow a user to select features of the application. Device 310 may also be a personal computer 220 or laptop 230 as described earlier. While not required, it may be more beneficial for device 310 to be in the same room as display unit 240, so that the location of device 310 may be referred to within the content played on display unit 240. For example, device 310 may provide a menu of the content files played on display unit 240 for that particular day, and may further provide, upon selection of a particular content file from the menu, a fact sheet and contact information for that particular content file. In another example, a coupon may be given in addition to or in replacement of a fact sheet. Additionally, device 310 may be connected to a printing device, allowing a user to print the fact sheet described above and take it with them. Device 310, when used in conjunction with display unit 240, may allow a content provider to put their information in a physical and portable form that may later serve as a reminder of their advertisement and possibly lead to greater effectiveness of the content provider's marketing efforts. Alternatively, device 310 may prompt a user to enter a valid email address, and any information requested by the user may be sent to the entered email address. It should be understood that any sort of information may be displayed in device 310, and should not be limited to only content playlist summaries. Also, because the information displayed on device 310 may be provided to device 310 remotely by system administrator, content providers may have their provided information edited at any time, without the need to send a representative to the establishment containing local network 30.

System 10 may be in continuous operation, providing content and other data to local networks 30 around the clock, or for any portion of a particular day, and for different times of day for different days of the week. For example, system 10 may run only during all open office hours when local network 30 is within a doctor's office, or it may run continuously, such as in a hospital emergency waiting room. The schedules of operation may be determined according to agreements between the system administrator and the establishment containing local network 30.

Content providers may be billed for the displaying of their content file within a playlist or streaming video mechanism in accordance with predetermined billing rates contracted between the system administrator and the content provider. For example, such billing rates may be based on the number of seconds it takes to run their content file multiplied by the number of times their file may run. Billing rates may be variable according to the time of day, or variable by what day of the week their content file may run. This process may be calculated manually by the system administrator, or may be an automated process based on log records of the processing unit 205 in local networks 30 and central server 20, or may be any combination of manual and automated processes.

An encryption standard may also be used to protect files from unauthorized interception over the network. Any encryption standard or authentication method as may be understood by those having ordinary skill in the art may be used in system 10. For example, this may be accomplished by central server 20 encrypting the output file by using a Secure Socket Layer (SSL) with dual key encryption, since a high degree of security may be desired by some of the content providers.

The present invention may also include an internet portal for receiving and accessing information. Such an application service portal may, for example, allow a physician to complete questionnaires or surveys from businesses, medical associations or other relevant organizations. It may also provide companies with a mechanism for relaying product warnings or other events requiring quick dissemination of information, or, it may simply serve as a quick reference tool for a doctor to find information relating to a specific drug or medical device.

In another example, the internet portal may be provided to patients in a medical office waiting room or a hospital emergency room, or to students in a medical school lounge, library or cafeteria. In this example, the present invention may also provide any number of the features described above in addition to educational information and educationally oriented tutorials of products and devices related to the practice of medicine.

Internet accessibility through system 10 may range from completely open, allowing a user to access not only the portal of system 10, but all other available websites, or it may be limited in any manner, such as restricting connectivity to only the system 10 internet portal, or to the system 10 internet portal and websites owned and operated by any assortment of participating content providers, for example.

The application service portal architecture may include a software framework that optimizes ease of use of at least one existing software platform, and that may also extend the capabilities of at least one existing software platform. The application service portal architecture may approximate the actual way users organize and conduct use activities, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of system 10 to create components that plug into the architecture. Thus, portals in the architecture may be extensible, and new portals may be created for the architecture by any party.

The internet portal may provide, for example, applications accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The internet portal may also provide a master GUI set that allows a user to select or interact with GUIs of one or more other applications, or that allows a user to simultaneously access a variety of information otherwise available through any portion of system 10.

The internet portal may be a portal that provides, via the GUI, remote access to and from the present invention. The portal may be, for example, a network browser. The portal may include the ability, either automatically based upon a user request in another application, or by a user request, to “hook”, search, or otherwise retrieve particular data from one or more remote points, such as on the internet. The portal may vary by user type, or may be available to only a certain user type, such as a physician, for example.

Presentation of data through the internet portal may be in any sort and number of selectable formats. For example, a multi-layer format may be used, wherein additional information is available by viewing successively lower layers of presented information. Such layers may be made available by the use of drop down menus, tabbed pseudo-manila folder files, or other layering techniques understood by those skilled in the art. Formats may also include AutoFill functionality, wherein data may be filled responsively to the entry of partial data in a particular field by the user. All formats may be in standard readable formats, such as XML.

The systems administrator may limit, for example, data manipulation, or information access. For example, the system administrator may allow for administration at one or more levels, such as at an individual user level, or at a system level. The system administrator may also implement access or use restrictions for users at any level. Such restrictions may include, for example, the assignment of user names and passwords that allow the use of the present invention, or the selection of one or more data types that the subservient user is allowed to view or manipulate.

Individual user accounts may be established to customize information or to target information or promotional material to particular users or set of users. Individual email accounts may also be established via the internet portal, or previously existing email accounts may be associated with individual user accounts to allow system 10, content providers, or other organizations participating in system 10 to send email messages to any particular user or group of users.

The internet portal may allow a user to perform tasks commonly associated with internet portals, such as, for example, e-mail, forums, search engines, and purchasing or other transactions. For example, the user may search generally through the internet portal, or may use any sort of searching parameters as desired by the user. Any single or combination of parameters may be used according to the needs of the user. Results of such a search may be viewed in a listing format, or any other format understood by those skilled in the art of displaying search results.

In another example, the internet portal may allow a user, such as a physician, to complete a questionnaire to aid in the collection of market relevant information for a company product. To do this, the physician may, for example, select a “Questionnaires” link from a web page, further select any number of questionnaires provided by the participating organizations who have submitted questionnaires into system 10, and complete the selected questionnaire as instructed. The information requested and the formatting used within a questionnaire may vary according to the needs of the receiving providers or other involved entities.

In another example, a user, such as a physician, may access the internet portal through any device, such as a desktop computer or a PDA, and collect quick reference information. For example, when the physician is with a patient and is contemplating an uncommon diagnosis for that patient, the doctor may access information via the internet portal to aid in correctly making the diagnosis. This information may be resident on a database of system 10, or may be found from another source, such as the American Medical Association or other reliable medical information resource, via the internet. In another example, the physician, or the patient visiting the physician, may have interest in a particular drug or medical device and require specific product information. Pharmaceutical companies or medical device manufacturers may provide this information directly into the system 10 databases, or may provide links via the internet portal for obtaining the requested information. Such a quick referencing service may create a better efficiency for the physician and may improve the accuracy of disseminated medical advice.

In another example, a user, who is not a physician, having his own computing device capable of recognizing a wireless signal, may access and view the internet portal of system 10 when within the range of a wireless local network 30. Such a system may allow a person waiting in the waiting room to discreetly receive the information available through system 10 through their personal wireless device, and further allowing other users in local network 30 to use any of the devices provide by system 10 in local network 30.

In another example, a participating organization to system 10, such as a pharmaceutical company, may send time sensitive information to participating users, such as physicians prescribing a particular drug, or patients who have been prescribed a particular drug. As may sometimes occur, post drug approval testing may create a situation where a drug must be recalled, or a new limitation on how to use the drug must be implemented. In these situations, the present invention may provide an alerting mechanism of the new drug information to users. Such alerting mechanisms may be, for example, an email, a pager signal, a web page pop-up, a streaming video message, or any other mechanism communicable via system 10.

In another example, a participating organization to system 10, such as a producer of infant formula, may provide a mechanism to make sales and/or deliver product samples to participating physicians of system 10, or to any targeted user or group of users of the internet portal as chosen by the producer of infant formula. Mechanisms for making product sales and/or providing delivery of product samples may be through surveys, questionnaires, or promotions, all selectable through the internet portal, or via email, or internet advertisements, which may be presented to the user via the internet portal. Such internet advertising may be in any web advertising format as understood by those skilled in the art. This may allow the present invention to act as an electronic sales representative. Such a service may cut out the frustration or annoyance felt by a physician of having a sales representative take away valuable office time from the physician and/or office staffing. Thus, the present invention may provide direct contact with every person in a doctor's office, and may provide virtually every service activity normally provided by a sales representative through connecting to the doctor's office via the internet portal, or content played on display units 240, while eliminating annoying office visits and cutting the costs attributed to sales representative salaries and travel expenses.

In another aspect of the present invention, a rewarding system may be used with the internet portal to provide incentives for users to take certain actions or participate in activities. Such rewarding systems may include any form of reward, such as gifts or monetary benefits, points in a points system, such as in a loyalty program, or any other rewards system understood by those skilled in the art. Rewards may be awarded to users and redeemable in any manner as determined by the reward providing entity. The reward providing entity may be system 10, or any content provider or other organization participating in system 10.

Referring again to FIGS. 2 and 3, a desktop computer 220 may also be provided in waiting rooms or other publicly accessible rooms of local network 30 establishments, where any of the content described herein may be played or accessed through the system 10 internet portal. Such a system 10 portal may also be accessible from end-user devices 40 as described in FIG. 1. For example, content similar to that which may have been incorporated into playlists for display in medical office waiting rooms may be provided to end-user devices 40 via pop-up ads, selectable ads from a list, or any other method for presenting content through a web site as understood by those skilled in the art. Promotional material, such as product samples or coupons, may also be offered via the system 10 internet portal. Also, a reward system, as described above, may be accessible to the public via the system 10 portal, with such rewards being tailored to the public instead of licensed medical professionals.

In another example, video presentations provided by doctors may be used in a video library accessible to the public through the system 10 portal, or licensed to medical care providers and/or insurance groups that may want to provide selectable videos to consumers who may be trying to decide which doctor to choose as their primary care physician or particular specialist. Individual doctor video presentations may be organized for selection by consumers in any way desirable.

Billing for content on the system 10 internet portal may follow standard billing practices for internet advertising, or any other billing system understood by those having ordinary skill in the art.

In another embodiment of the present invention, a printing function may be used to print information related to the provided content, the internet portal, or any other aspect of system 10 in a form a user may take with them out of the local network 30 establishment. For example, a printer may be attached to a desktop computer in a medical office waiting room, and may be suitable for printing information from the system 10 internet portal, such as, for example, results from a search made by a user. In another example, a printer may be linked to a touchscreen device 310 displaying a menu that provides information related to the content playing on a display unit 240, where a user, after seeing a particular advertisement on display unit 240, may go to the touchscreen menu, select that particular advertisement from a list of the advertisements in the playlist, and receive a printout of information related to that particular advertisement. The printer may print any size and number of pages, such as regular, letter sized pages, or smaller, receipt style pages that fit easily into a wallet. The printing function may be associated with any device in local network 30 or other computing device capable of connecting to local networks 30, or to system 10 generally.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

1. A system for the distribution and display of multimedia content to at least one remote location, said system comprising:
a first server for storing and sending multimedia content;
a second server located in at least one location remote from said first server, wherein said second server is communicatively connected to said first server via a network;
at least one display unit communicatively connected to said second server for displaying said multimedia content;
wherein said first server selectively sends said multimedia content to said second server for displaying on said at least one display unit at said at least one location remote from said first server; and
wherein said multimedia content is individually customized for each of said at least one location remote from said first server.

2. The system of claim 1, wherein said multimedia content is in a processor readable format.

3. The system of claim 1, wherein said multimedia content is in high definition.

4. The system of claim 2, wherein said multimedia content is compiled into a playlist.

5. The system of claim 2, wherein said multimedia content is streamed from said first server to said second server.

6. The system of claim 1, wherein said multimedia content includes at least one advertisement.

7. The system of claim 1, wherein said multimedia content includes educational material.

8. The system of claim 1, wherein said multimedia content includes a header portion providing a real-time feed of information.

9. The system of claim 1, wherein said at least one location remote from said first server is a medical office.

10. The system of claim 1, further comprising an information device, wherein said information device displays information related to said multimedia content displayed on said at least one display unit.

11. The system of claim 10, wherein said information device is a printed pamphlet.

12. The system of claim 10, wherein said information device is an electronic computing device communicatively connected to said second server.

13. The system of claim 12, wherein at least a portion of said information relating to said multimedia content may be selected from a selectable menu of said information related to said multimedia content.

14. The system of claim 13, wherein said electronic computing device further comprises a touchscreen for selecting from said selectable menu.

15. The system of claim 13, further comprising a printer for printing said at least a portion of said information related to said multimedia content.

16. The system of claim 1, wherein said multimedia content is reviewed by a review board prior to being sent to said second server.

17. The system of claim 1, further comprising at least one portable computing device communicatively connected to said second server, wherein said multimedia content is viewable on said at least one portable computing device.

18. The system of claim 17, wherein said at least one portable computing device is selected from the group consisting of a laptop, PDA and a phone.

19. The system of claim 1, further comprising an internet portal hosted by a webserver communicatively connected to said first and said second servers, wherein said internet portal is accessible by a computing device communicatively connected to said first or said second server.

20. The system of claim 19, wherein access to said internet portal requires membership to a website.

21. The system of claim 19, wherein said multimedia content is distributed and displayed through said internet portal.

22. The system of claim 21, wherein said multimedia content distributed and displayed through said internet portal is individually targeted for each membership of said website.

23. The system of claim 21, further comprising a printer for printing at least a portion of said multimedia content.

24. A system for the distribution and display of multimedia content to at least one remote location, said system comprising:
a first server for storing and sending multimedia content, and for selectively sending said multimedia content to a second server communicatively connected to said second server for displaying on at least one display unit at said at least one location remote from said first server; and
wherein said multimedia content is individually customized for each of said at least one location remote from said first server.

25. A method for distributing and displaying multimedia content to at least one remote location, said method comprising:
selecting multimedia content stored on a first server;
selecting a second server located in at least one location remote from said first server; wherein said second server is communicatively connected to said first server via a network;
transmitting said multimedia content from said first server to said second server; and
displaying said multimedia content on at least one display unit communicatively connected to said second server, wherein said multimedia content is individually customized for each of said at least one location remote from said first server.
